(19) United States
(12) Patent Application Publication
(10) Pub. No.: US 2011/0010718 A1
(43) Pub. Date: Jan. 13, 2011

(54) ELECTRONIC DEVICE, INFORMATION PROCESSING METHOD, AND COMPUTER PROGRAM PRODUCT HAVING COMPUTER-READABLE INFORMATION PROCESSING PROGRAM

(76) Inventors: Mayu KONDO, Chiba (JP); Hidehiko Watanabe, Kanagawa (JP); Suntao Yan, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/829,719

(22) Filed: Jul. 2, 2010

(30) Foreign Application Priority Data
Jul. 7, 2009 (JP) 2009-161105

(51) Int. Cl. G06F 9/46; G06F 13/24

(52) U.S. Cl. 718/102; 710/260

(57) ABSTRACT

An electronic device includes a status management unit detecting a change in a status of the electronic device and recognizing the status; an added program control unit applying an added program to a program of the electronic device in response to a validation request for the added program, the added program being capable of dynamically interrupting the program of the electronic device with a process; and an application determination information storage unit storing application determination information indicating whether the added program can be applied to the program of the electronic device depending on the status of the electronic device recognized by the status management unit. The added program control unit determines whether the added program can be applied based on (1) the status of the electronic device recognized by the status management unit upon reception of the validation request, and (2) the application determination information.

### BACKGROUND OF THE INVENTION

1. Field of the Invention

The present invention generally relates to an electronic device capable of executing an interrupting program, an information processing method performed by the electronic device, and a non-transitory computer-readable recording medium storing an information processing program.

2. Description of the Related Art

In a typical example of a fault analysis (such as debugging) operation performed on a program running on a device, particularly an embedded device, a log output of the program is analyzed. Specifically, log output instructions (such as the “printf” function in C language) for outputting log information to a log file are embedded at various locations in a source code of the program. The log information may indicate the values of variables used by the program, or the status of hardware on which the program runs. In case of a fault, the log file is analyzed in order to infer or identify the cause of the fault.

However, such a log file (the initially outputted log file) outputted in accordance with the embedded log output instructions may not provide sufficient information for detailed analysis. In such a case, the location of the fault may be generally determined first based on the initially outputted log file. Then, the program may be replaced by modifying the source code and performing compiling and linking so that a log that provides more detailed information about the location of the fault can be obtained. If the cause of the fault cannot be identified by a newly obtained log file, an additional log output instruction may be embedded in the source code, and then the above operation may be repeated. Thus, log-based fault analysis can sometimes require very cumbersome operations.

Japanese Laid-Open Patent Application No. 2008-269163 discusses a technique for overcoming the above problem. The technique involves dynamically interrupting the program with a process of a diagnosis program at a desired location (“diagnosed position”) as the program is running (or being executed). Within the diagnosis program, values of variables and the like of the target program (that is interrupted) may be referred to. At the end of the diagnosis program, the process returns to the diagnosed position of the target program. According to this technique, a log of the target program may be obtained, the target program may be debugged, or function extension may be provided without modifying the source code of the program. Further, a user of the diagnosis program may transmit the diagnosis program via a network to a device on which the target program runs, thus allowing the user to control the execution of the diagnosis program via the network. Such remote-controlling capability of the diagnosis program is very useful for the user, such as personnel in charge of fault analysis.

However, because such a diagnosis program may be applied regardless of the status of the target program, the operation of the target program or that of the device controlled by the target program may be destabilized, depending on the timing of application of the diagnosis program. For example, if, during the execution of a job in the device, a program involved in the execution of the job is interrupted by a process of a diagnosis program that is inappropriate during the execution of the job, the process of the job may be destabilized.

On the other hand, there are some diagnosis programs that would be meaningless unless applied during the execution of a job. For example, a diagnosis program for recording a log of the target program as the job is being executed needs to be applied during the execution of the job.

### SUMMARY OF THE INVENTION

The disadvantages of the prior art are overcome by the present invention which, in one aspect, is an electronic device including a status management unit detecting a change in a status of the electronic device and recognizing the status; an added program control unit applying an added program to a program of the electronic device in response to a validation request for the added program, the added program being capable of dynamically interrupting the program of the electronic device with a process; and an application determination information storage unit storing application determination information indicating whether the added program can be applied to the program of the electronic device depending on the status of the electronic device recognized by the status management unit. The added program control unit determines whether the added program can be applied based on the status of the electronic device recognized by the status management unit upon reception of the validation request, and the application determination information.

In another aspect, the invention is an information processing method performed by an electronic device. The method includes a status managing step of detecting a change in a status of the electronic device and recognizing the status of the electronic device; and an added program control step of applying an added program to a program of the electronic device in response to a validation request for the added program, the added program being capable of dynamically interrupting the program of the electronic device with a process. The added program control step includes determining whether the added program can be applied in accordance with the validation request based on the status of the electronic device recognized by the status managing step in response to the validation request, and application determination information stored in an application determination information storage unit of the electronic device. The application determination information indicates whether the added program can be applied depending on the status of the electronic device.

In another aspect, the invention provides a computer program product comprising a computer-readable information processing program embodied in a non-transitory computer-readable medium and including a program code to be executed by a computer to perform a status managing step of detecting a change in a status of the electronic device and recognizing the status of the electronic device; and an added program control step of applying an added program to a program of the electronic device in response to a validation request for the added program. The added program is capable of dynamically interrupting the program with a process. The added program control step includes determining whether the added program can be applied to the program of the electronic device in accordance with the validation request based on the status of the electronic device recognized by the status managing step in response to the validation request, and application determination information stored in an application determination information storage unit of the electronic device. The application determination information indicates whether the added program can be applied depending on the status of the electronic device.

### BRIEF DESCRIPTION OF THE DRAWINGS

A complete understanding of embodiments of the present invention may be obtained by reference to the accompanying drawings, when considered in conjunction with the subsequent, detailed description, in which:

FIG. 1 illustrates a device management system according to an embodiment of the present invention;

FIG. 2 illustrates an example of an added program;

FIG. 3 illustrates a hardware structure of a device according to the present embodiment;

FIG. 4 illustrates a software structure of the device according to the present embodiment;

FIG. 5 is a sequence diagram of a process sequence for executing a copy job according to Embodiment 1;

FIG. 6 is a flowchart of a process sequence of an added program control unit according to Embodiment 1;

FIG. 7 illustrates an example of a job-executing application determination table according to Embodiment 1;

FIG. 8 is a sequence diagram of a first process sequence of a process in which validation of an added program for the ECS is requested in a job-executing status;

FIG. 9 is a sequence diagram of a second process sequence of the process in which validation of an added program for an ECS is requested in a job-executing status;

FIG. 10 is a sequence diagram of a third process sequence of the process in which validation of an added program for the ECS is requested in a job-executing status;

FIG. 11 is a sequence diagram of an offline status transition process;

FIG. 12 illustrates various modes of the offline status;

FIG. 13 is a flowchart of a process sequence of the added program control unit according to Embodiment 2;

FIG. 14 illustrates an example of an offline-mode-based application determination table according to Embodiment 2;

FIG. 15 illustrates an example of an offline-acquirer-based application determination table according to Embodiment 2;

FIG. 16 is a sequence diagram of a first process sequence in a process in which validation of an added program is requested in the offline status;

FIG. 17 is a sequence diagram of a second process sequence of the process in which validation of an added program is requested in the offline status;

FIG. 18 illustrates an example of a power status transition according to Embodiment 3;

FIG. 19 is a sequence diagram of a process sequence when the quiet status transitions to the normal power status;

FIG. 20 is a flowchart of a process sequence of the added program control unit according to Embodiment 4;

FIG. 21 illustrates an example of a validation condition table according to Embodiment 4;

FIG. 22 is a sequence diagram of a first process sequence of an added program validation process depending on a device status change; and

FIG. 23 is a sequence diagram a second process sequence of the added program validation process depending on the device status change.

### DETAILED DESCRIPTION OF THE PREFERRED EMBODIMENTS

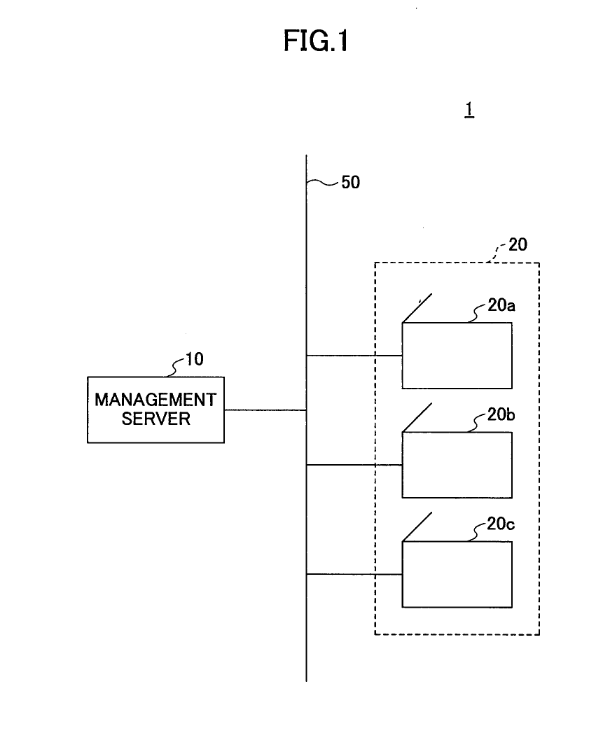

Referring now to the drawings, wherein like reference numerals designate identical or corresponding parts throughout the several views, FIG. 1 is a block diagram of a device management system 1 according to an embodiment of the present invention. The device management system 1 includes a management server 10 and devices 20a, 20b, and 20c (any of which may be hereafter referred to as “the device 20”). The management server 10 and the devices 20 are connected via a network 50 which may be wired or wireless, such as a LAN (local area network) or the Internet.

The device 20 may include an image forming apparatus, such as a multifunction peripheral (MFP) that realizes the multiple functions of a copier, a facsimile machine, a printer, and/or a scanner within a single enclosure. The device 20 includes a CPU and a memory. Various functions of the device 20 may be realized by the CPU controlling various hardware units of the device 20 in accordance with a program stored in the memory. The device 20 is an example of an electronic device.

The management server 10 may include a computer configured to manage the execution of an added program applied to a program (“target program”) used in the device 20. The computer may also be configured to manage the transfer of the added program to the device 20. In accordance with the present embodiment, the “added program” refers to a program that can cause a target program to be dynamically interrupted with a process defined by the added program at a desired location of the target program.

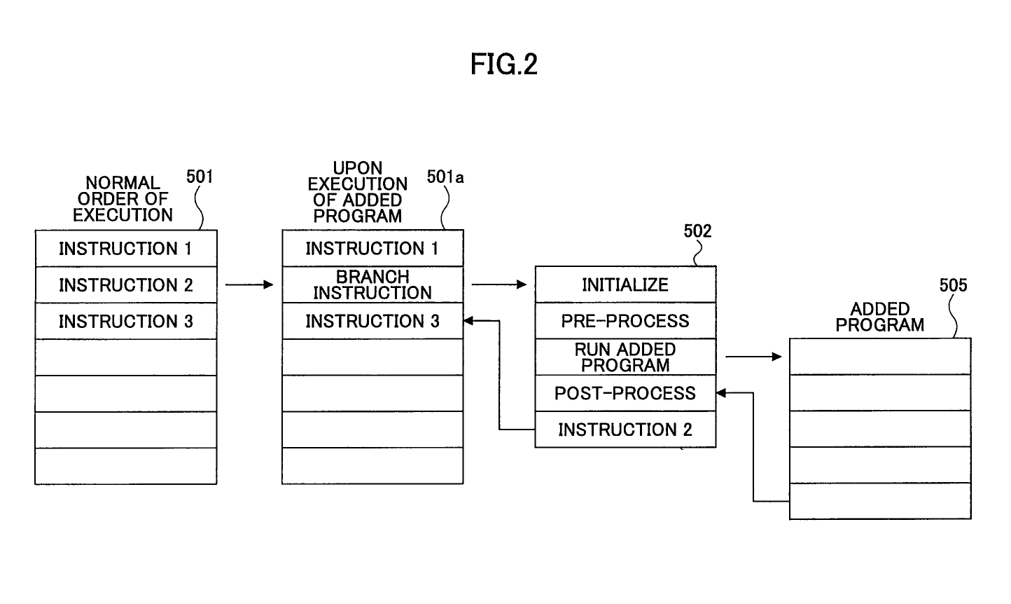

FIG. 2 illustrates an example of the added program. In FIG. 2, a target program 501 contains a sequence of instructions 1, 2, 3, and so on that are executed from a virtual memory in the mentioned order, before the added program 505 is applied (at the time of normal execution). Numeral 501a designates the target program 501 to which the added program 501 is applied, where the target program 501 is interrupted by a process of the added program 505 between the instructions 1 and 2. In this case, the execution of the instruction 2 is replaced with the execution of a branching instruction for a table 502.

The table 502 contains definitions such that the instruction 2 is executed after performing initialization, pre-processing (such as placing a variable into a stack), calling the added program 505, and post-processing (such as recovering the variable from the stack), before returning to the instruction 3 of the program 501.

Thus, the process of the added program is executed when an execution step of the target program reaches a pre-designated location (added position). Upon completion of the process of the added program, process control returns to the target program. Thereafter, the target program resumes a process from the added position. The added program may contain information identifying the target program and the added position, in addition to the process with which the target program is interrupted.

In the added program, variables and the like of the target program may be referred to. Thus, the added program can cause the target program to be interrupted with various processes, such as a process for outputting log information about the value of a variable at a desired location of the target program, a process for correcting bugs, or a process for realizing a new function. Thus, the added program enables the target program to output log information, correct bugs, or enhance its functions dynamically, without performing modification of the source code, compiling and linking, or reinstalling.

In accordance with the present embodiment, the process of applying the added program to the target program and making the added program executable (FIG. 2) is referred to as “validation” of the added program. Namely, the added program does not function when it is merely stored in the device 20, and cannot interrupt the target program with a process until validated.

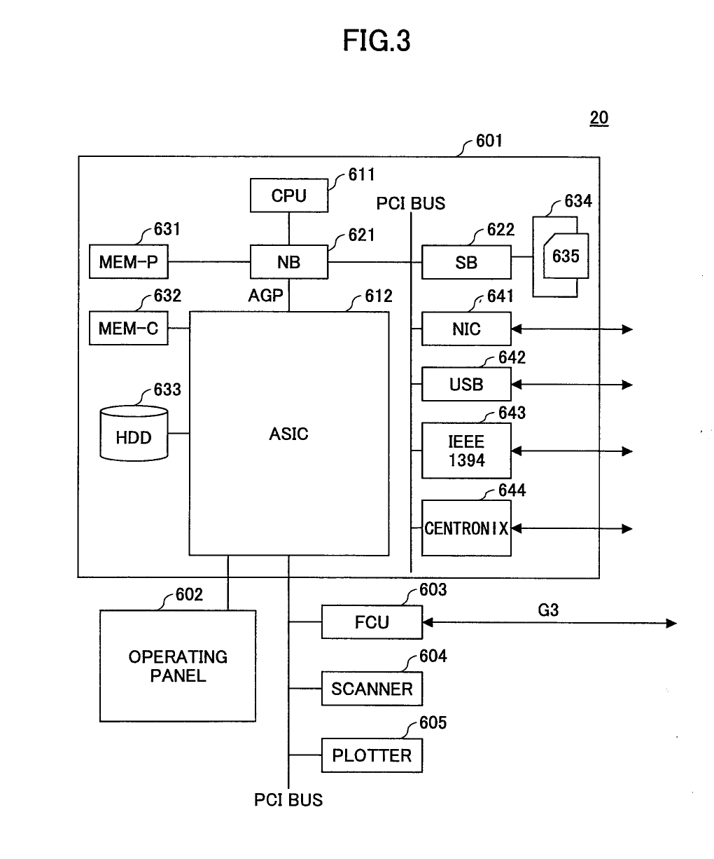

The device 20 is described in greater detail with reference to FIG. 3, which illustrates a hardware structure of the device 20 according to an embodiment of the present invention. The device 20 includes a controller 601, an operating panel 602, a facsimile control unit (FCU) 603, a scanner 604, and a plotter 605.

The controller 601 includes a CPU 611, an ASIC (application specific integrated circuit) 612, an NB (north bridge) 621, a SB (south bridge) 622, a MEM-P 631, a MEM-C 632, a HDD (hard disk drive) 633, a memory card slot 634, a NIC (network interface controller) 641, a USB (universal serial bus) device 642, an IEEE 1394 device 643, and a Centronics device 644.

The CPU 611 may include an IC (integrated circuit) configured to process various information. The ASIC 612 is an IC for performing various image processes. The NB 621 is a north bridge of the controller 601. The SB 622 is a south bridge of the controller 601. The MEM-P 631 is a system memory of the device 20. The MEM-C 632 is a local memory of the device 20. The HDD 633 is a storage of the device 20. The memory card slot 634 is a slot into which a memory card 635 can be inserted. The NIC 641 is a network communication controller using a MAC address. The USB device 642 provides a USB-standard connection terminal. The IEEE 1394 device 643 provides a connection terminal according to the IEEE 1394 standard. The Centronics device 644 provides a Centronics-standard connection terminal. The operating panel 602 provides a hardware unit (operating unit) for allowing an operator to perform various input operations on the device 20. The operating panel 602 also provides a display unit allowing the operator to gain outputs from the device 20. The scanner 604 is a hardware unit for reading image data from a manuscript which may be a sheet of paper. The plotter 605 is a hardware unit for transferring an image onto a recording medium, such as a print paper.

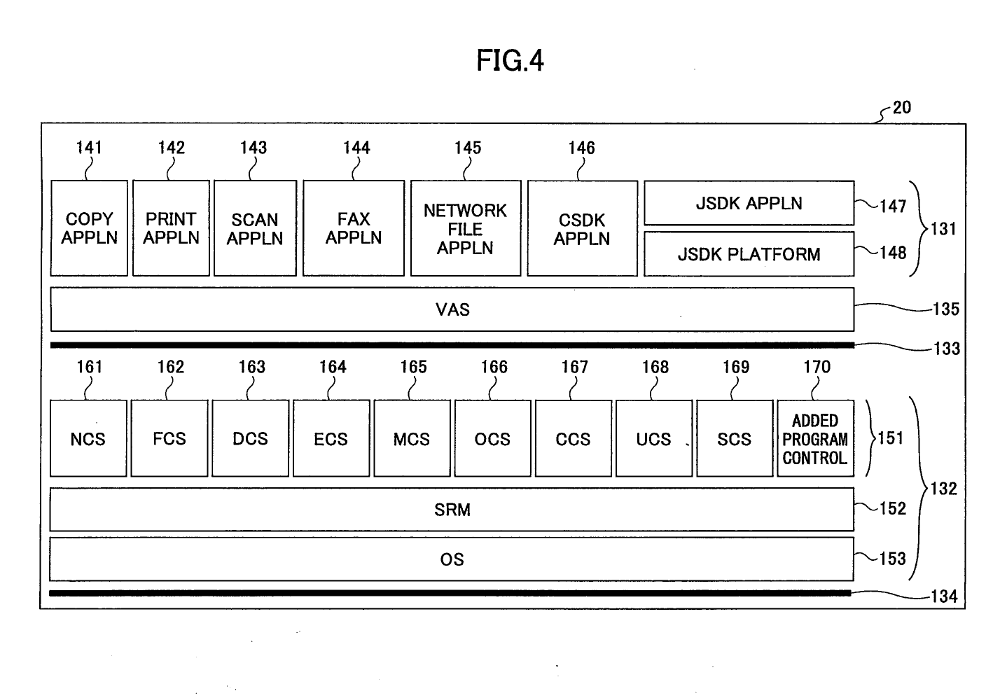

FIG. 4 illustrates a software structure of the device 20 according to the present embodiment. The device 20 includes various programs, which may be largely categorized into an application 131 and a platform 132. Two or more of the programs may be executed in parallel by an OS (operating system) 153, such as UNIX, on a process by process basis.

The application 131 includes a copy application 141, a printer application 142, a scanner application 143, a facsimile application 144, and a network file application 145. The application 131 may be developed using a dedicated SDK (software develop kit). An application 131 developed using a SDK may be referred to as a “SDK application”. Examples of dedicated SDK applications include “CSDK” for developing the application 131 using C language; and “JSDK” for developing the application 131 using Java language. The application 131 developed using CSDK may be referred to as a “CSDK application”; the application 131 developed using JSDK may be referred to as a “JSDK application”.

The device 20 illustrated in FIG. 4 includes a CSDK application 146. The device 20 further includes a JSDK application 147 written in Java language, and a JSDK platform 148 that provides a software interface with other software written in C language. Specifically, the JSDK platform 148 is equipped with an API (application program interface) for supplying the functions provided by a control service 151 and the like, to the JSDK application 147. In other words, the JSDK platform 148 provides common functions to plural of the JSDK applications 147.

The platform 132 includes the control service 151 and a system resource manager (SRM) 152. The control service 151 includes a network control service (NCS) 161, a facsimile control service (FCS) 162, a delivery control service (DCS) 163, an engine control service (ECS) 164, a memory control service (MCS) 165, an operating panel control service (OCS) 166, a certification control service (CCS) 167, a user directory control service (UCS) 168, a system control service (SCS) 169, and an added program control unit 170.

The NCS 161 provides a network communications interface. The FCS 162 provides an API for the facsimile function. The DCS 163 controls a stored document distributing process. The ECS 164 controls jobs involving the scanner 604, the plotter 605, and the like. The application 131 executes jobs via the ECS 164. The MCS 165 controls memories or the hard disk drive, for example. The OCS 166 controls processes related to the operating panel 602. The CCS 167 controls processes of authentication or accounting, for example. The UCS 168 controls management of user information. The SCS 169, which is an example of a status management unit, detects a change (transition) in status of the device 20 and recognizes a status of the device 20.

For example, the SCS 169 is notified of an event such as a change in status of the device 20 itself, or a change in status of any of the services in the control service 151. Upon such notice, the SCS 169 notifies one or more other program modules that require the notice of such an event. The added program control unit 170 provides software for realizing an environment for the execution of an added program. For example, the added program control unit 170 receives the added program transferred from the management server 10, and applies the added program to a target program (thus validating the added program).

The SRM 152 manages hardware resources via an engine interface 134. Specifically, the SRM 152 arbitrates requests from the control service 151 for utilization of the hardware resources. The engine interface 134 provides an interface with the scanner 604, the plotter 605, or other hardware resources.

A virtual application service (VAS) 135 provides a software interface between the application 131 and the platform 132. The VAS 135 may be configured to operate as a client process using the platform 132 as a server, or as a server process using the application 131 as a client. The VAS 135 may be configured to provide a wrapping function for hiding an API 133 of the platform 132 from the view of the application 131, thus absorbing changes resulting from a version upgrade of the API 133 of the platform 132.

### Embodiment 1

### Handling of Added Program Depending on Job Status

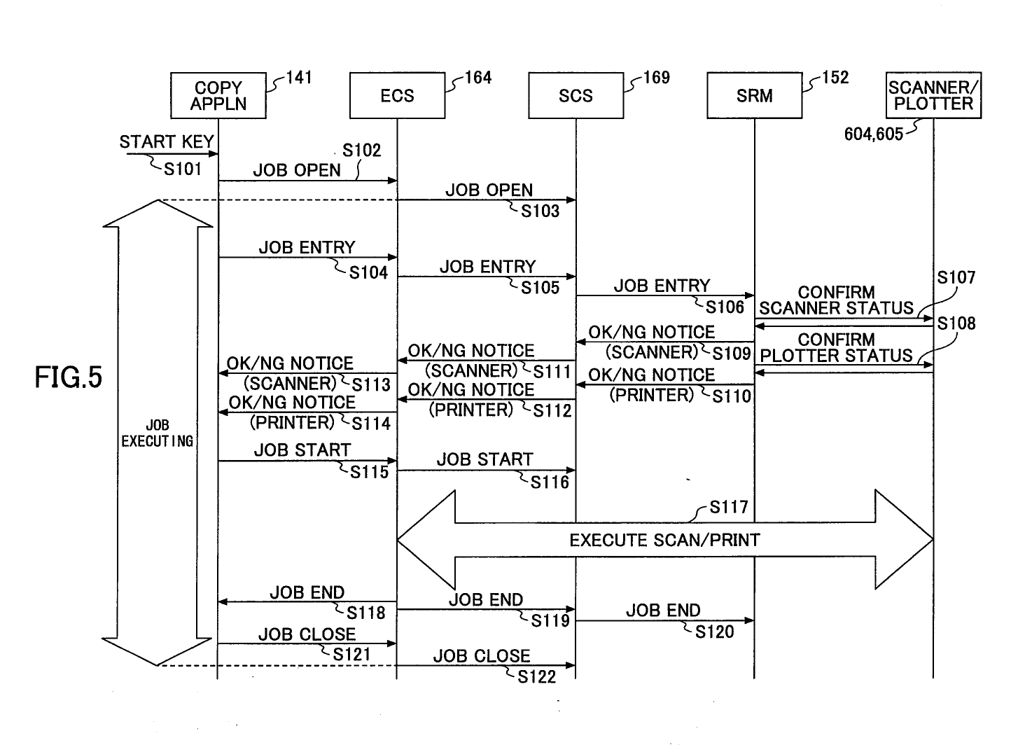

In the following, a process sequence of the device 20 according to Embodiment 1 is described, in which an added program is handled depending on an execution status of a job in the device 20. FIG. 5 is a sequence diagram of a typical process sequence for executing a copy job in the device 20. First, a user sets a manuscript at a predetermined position on the device 20, such as on an ADF (auto document feeder), and then presses a start key on the operating panel 602 (S101). Then, the copy application 141 notifies the ECS 164 of job open (S102). The ECS 164 notifies the SCS 169 of “job open” by the copy application 141 (S103). The “job open” is a declaration of the start of a job. The notice of “job open” to the SCS 169 allows the SCS 169 to recognize the transition of job status of the device 20 from an idle status (standby status) to a job-executing status. “Recognize” herein means that information identifying the job status is recorded in memory (such as MEM-P631), for example.

Thereafter, the copy application 141 requests “job entry” from the ECS 164 (S104), requesting entry of a copy job in a job queue as an execution target. Such a request may designate setting information (execution condition) for the copy job, or information about hardware resources (such as scanner 604 or plotter 605) that the copy job requires. The ECS 164 sends the job entry request from the copy application 141 to the SCS 169 (S105). The SCS 169 sends the job entry request to the SRM 152 (S106).

In response to the job entry request, the SRM 152 confirms the status of the scanner 604 or the plotter 605, for example, that the copy job requires (S107, S108), and then notifies the SCS 169 whether the scanner 604 or the plotter 605, for example, can be utilized (S109, S110). Such a notice is transmitted via the SCS 169 and the ECS 164 to the copy application 141 (S111 through S114).

When both the scanner 604 and the plotter 605 are utilizable, the copy application 141 sends a copy job start request to the ECS 164 (S115). The ECS 164 then notifies the SCS 169 of the start of the copy job (S116). Thereafter, the scanner 604 and the plotter 605, for example, are controlled by the ECS 1164 via the SCS 169 and the SRM 152, for example, whereby a manuscript copy operation is carried out (S117). More specifically, an image is read by the scanner 604, the image is subjected to predetermined image processing, and a resultant image is transferred (printed) on a record medium such as a print sheet by the plotter 605. When there is more than one manuscript, the manuscript copy operation may be repeated.

When the process is completed for all manuscripts, the ECS 164 sends a job end notice to the copy application 141 and the SCS 169 (S118, S119). The SCS 169 then sends a job end notice to the SRM 152 (S120). In response to the job end notice, the copy application 141 sends a job close request to the ECS 164 (S121). The ECS 164 then notifies the SCS 169 about the job close by the copy application 141 (S122). The “job close” is a declaration of end of a job. The notice of job close allows the SCS 169 to recognize the transition of the job status of the device 20 from a job-executing status to an idle status (standby status).

Next, the handling (control) of the added program by the added program control unit 170 in accordance with the job status of the device 20 that changes (transitions) as described with reference to FIG. 5 is described.

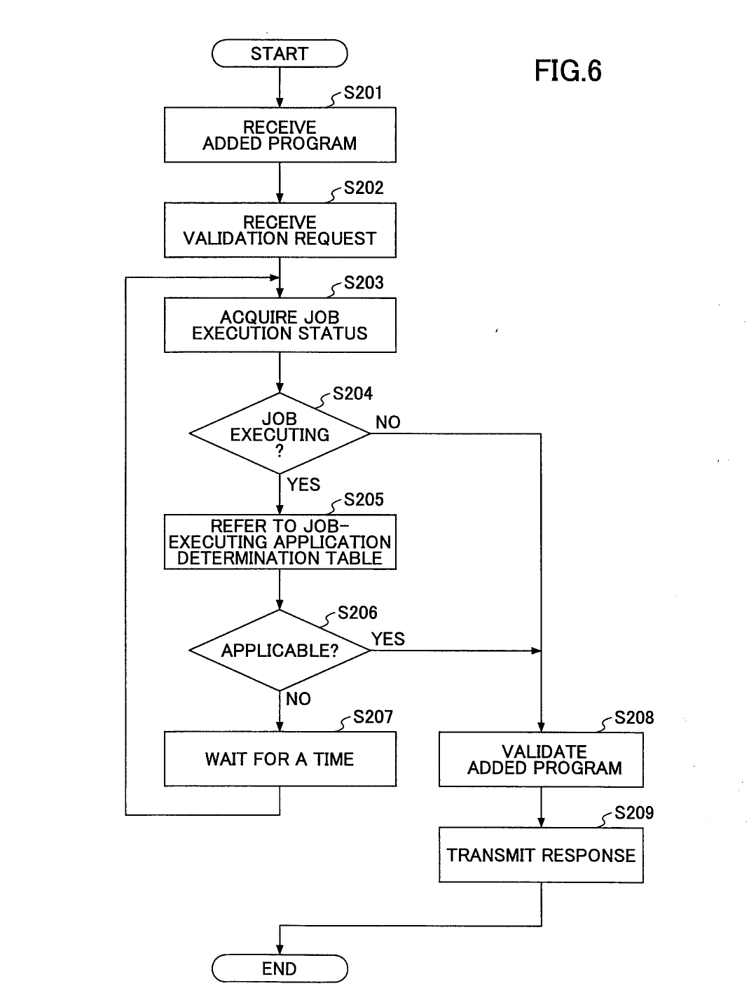

FIG. 6 is a flowchart of a process sequence of the added program control unit 170 according to the first embodiment. In step S201, the added program control unit 170 receives an added program from the management server 10, and records the added program in memory (such as MEM-P631). The added program may include information (target program ID) identifying a target program, and information (added program ID) identifying the added program.

Thereafter, the added program control unit 170 receives a validation request designating an added program ID from the management server 10 (S202). The transfer of the added program and the validation request from the management server 10 to the device 20 (added program control unit 170) is performed under the control of the management server 10. Namely, the added program as a transfer target or a validation target is selected by an operator of the management server 10, and the selected added program or a validation request for the program is transferred. Further, the transfer of the added program and the validation request may not occur in pairs. For example, the added program alone may be transferred first and then a validation request for the added program may be transferred at a later time.

In accordance with the validation request, the added program control unit 170 acquires the job status from the SCS 169 (i.e., queries the SCS 169 about the job status) (S203). This is because, as described with reference to FIG. 5, only the SCS 169 detects the job status transition and recognizes the current job status.

When the job status does not indicate that a job is being executed (NO in S204), the added program control unit 170 validates the added program (which may be the added program received in step S201) corresponding to the added program ID designated in the validation request (S208). As a result, the added program is applied to the target program, so that the process content of the target program is modified by a process of the added program. Thereafter, the added program control unit 170 transmits a response to the management server 10 indicating that the added program has been correctly validated (S209).

On the other hand, when the job status indicates that a job is being executed (YES in S204), the added program control unit 170 refers to a job-executing application determination table to determine whether the added program can be applied (S205).

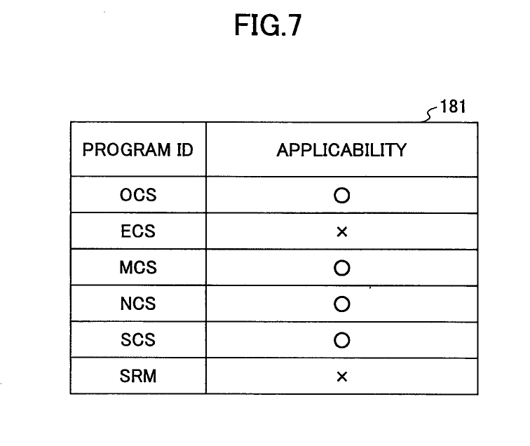

FIG. 7 is an example of the job-executing application determination table 181 according to the first embodiment. As illustrated, the job-executing application determination table 181 records (registers) information indicating, for each program ID of programs possessed by the device 20, whether an added program can be applied when the job status indicates that a job is being executed (“job-executing status”). In the job-executing application determination table 181, “Yes” indicates that the added program can be applied. “No” indicates that the added program cannot be applied. The job-executing application determination table 181 may be recorded in a non-volatile recording medium, such as the HDD 633, in advance.

Thus, the added program control unit 170 determines whether the added program can be applied by comparing the target program ID attached to the added program with the job-executing application determination table 181. If the determination provides a positive result (YES in S206), step S208 is performed as described above. If the determination result is negative (NO in S206), the added program control unit 170 stands by for a time and then repeats step S203 and the subsequent steps. Thus, in this case, validation of the added program is performed upon transition from the job-executing status to idle status (S208).

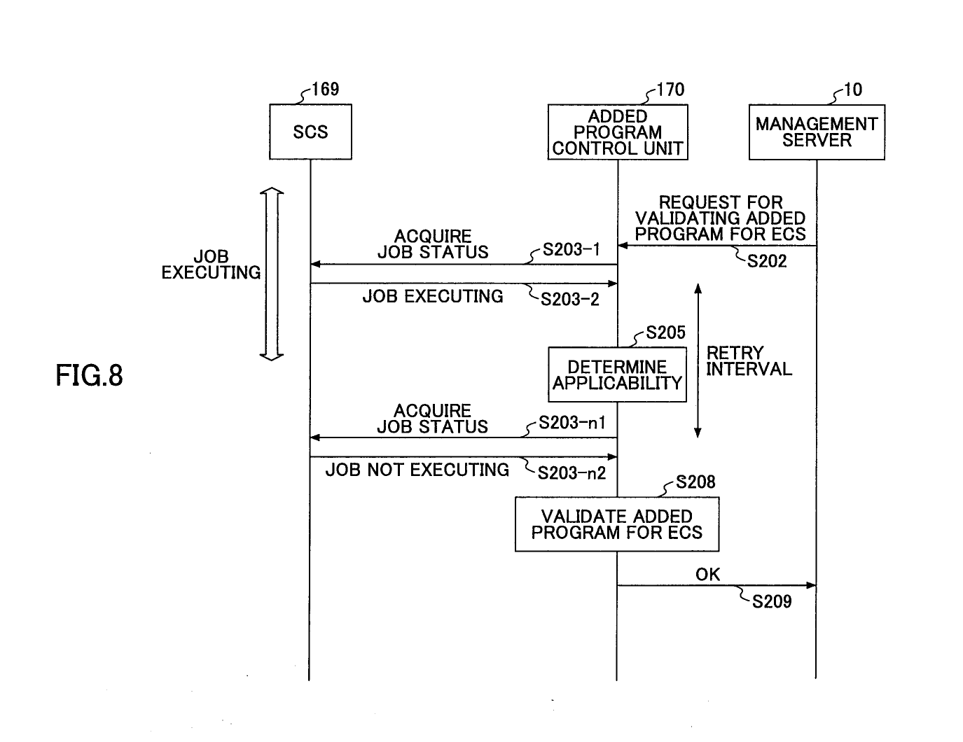

Next, the process sequence of FIG. 6 is described with reference to a more specific example. FIG. 8 is a sequence diagram of a first process sequence where validation of an added program to be applied to the ECS 164 has been requested during the execution of a job. In FIG. 8, steps similar to the steps of FIG. 6 are designated with similar step numbers.

In step S202, the added program control unit 170 receives an validation request from the management server 10 for an added program having a target program ID corresponding to the program ID of the ECS 164. In FIG. 8 and in the subsequent sequence diagrams or flowcharts, the step of receiving the added program is omitted.

Thereafter, the added program control unit 170 sends a query for a job status to the SCS 169 (S203-1). In response, the SCS 169 sends a reply indicating that a job is being executed (“job-executing status”) (S203-2). Thus, the added program control unit 170 refers to the job-executing application determination table 181 to determine whether the added program can be applied to the ECS 164 in the job-executing status (S205). The job-executing application determination table 181 illustrated in FIG. 7 indicates that the added program cannot be applied to the ECS 164 during execution of a job. Therefore, the added program control unit 170 repeats (retries) step S203 and the subsequent steps. Upon reception of a reply that the job is not being executed (“idle status”) (S203-n2) in response to the retried inquiry as to the job status to the SCS 169 (S203-n1), the added program control unit 170 validates the added program for the ECS 164 (S208). Thereafter, the added program control unit 170 transmits a reply to the management server 10 indicating that the added program has been correctly validated (S209).

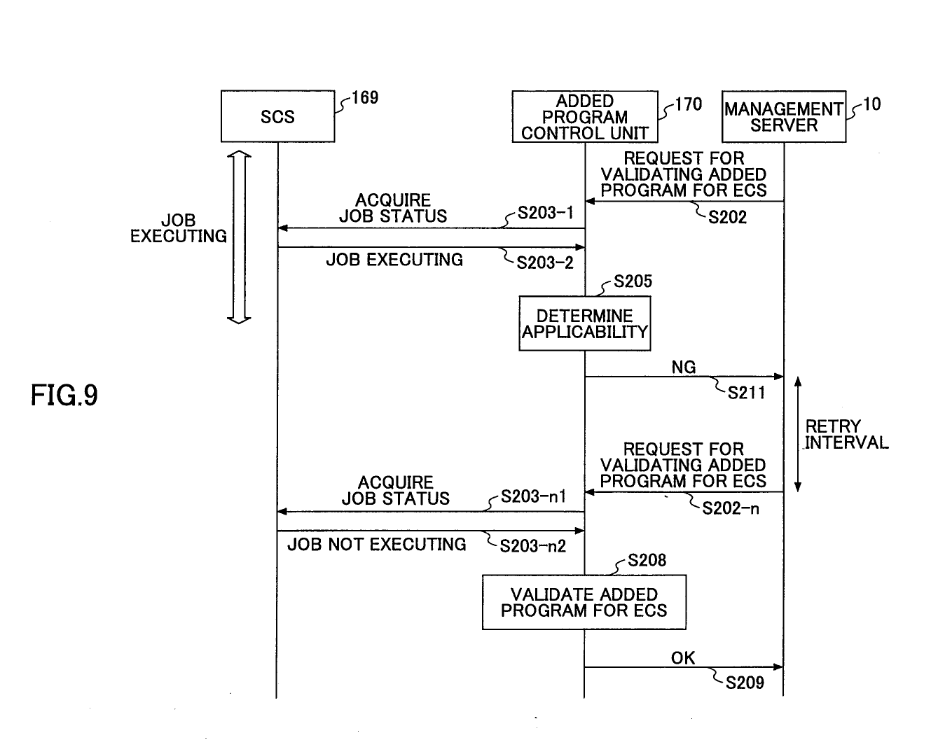

Next, a variation of the process sequence of FIG. 8 is described. FIG. 9 is a sequence diagram of a second process sequence job where an validation of an added program to be applied to the ECS 164 has been requested during the execution of a job. In FIG. 9, steps similar to the steps of FIG. 8 are designated with similar step numbers.

The sequence of FIG. 9 differs from the sequence of FIG. 8 in that the retry control in the case of a negative determination result in step S205 is performed by the management server 10. Specifically, when it is determined in step S205 that the added program cannot be applied, the added program control unit 170 transmits a reply to the management server 10 indicating that validation cannot be performed (NG) (S211). Thus, the management server 10 stands by for a time and then re-transmits an validation request for the added program for the ECS 164. When a job is being executed upon reception of the re-transmitted validation request, the added program control unit 170 again transmits a response to the management server 10 indicating that validation cannot be performed (NG).

When the re-transmitted validation request for the added program for the ECS 164 is received when a job is not being executed (S202-n), step S208 and the subsequent steps are performed, whereby the added program is validated.

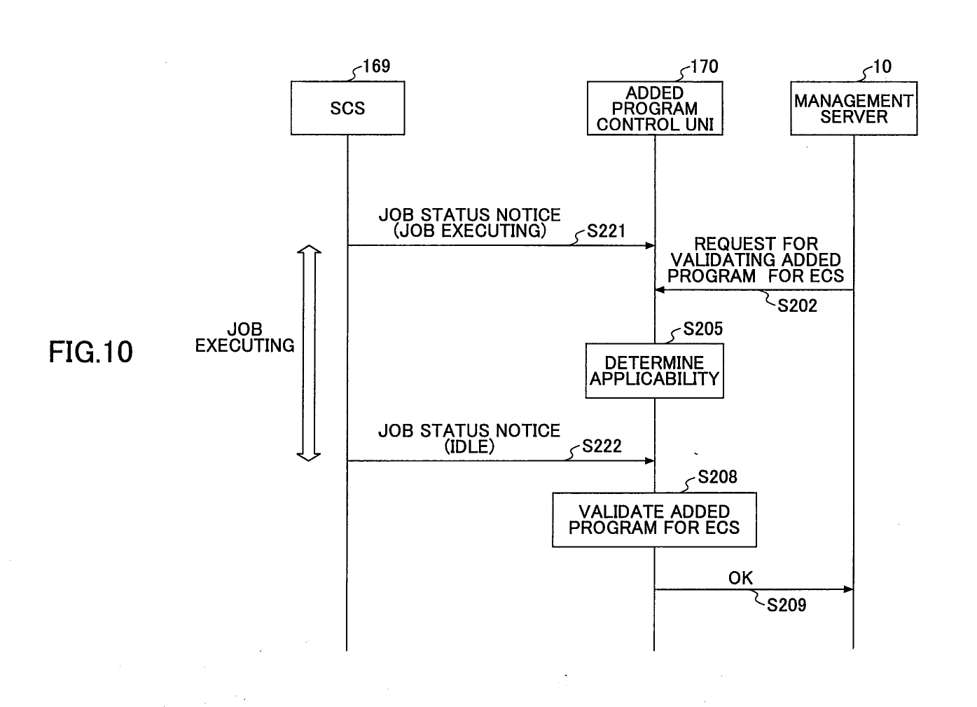

Next, another variation of the process sequence of FIG. 8 or 9 is described with reference to FIG. 10, which is a sequence diagram of a third process sequence where validation of an added program to be applied to the ECS 164 is requested during the execution of a job. In FIG. 10, steps similar to the steps of FIG. 8 or 9 are designated with similar step numbers.

The process sequence of FIG. 10 differs from the process sequence of FIG. 8 or 9 in that the SCS 169 notifies the added program control unit 170 about transition of job status without a query from the added program control unit 170.

Upon detection of transition of job status to the job-executing status, the SCS 169 notifies the added program control unit 170 (S221). In response to the notice, the added program control unit 170 recognizes that a job is being executed.

Thereafter, upon reception of a validation request from the management server 10 for the added program for the ECS 164, the added program control unit 170 determines whether the added program can be applied, by referring to the job-executing application determination table 181 (S205). When it is determined that the application is not allowed, the added program control unit 170 stands by until the job-executing status is gone.

Thereafter, in response to a notice from the SCS 169 indicating the transition of job status to the idle status (S222), the added program control unit 170 validates the added program (S208).

In the case of FIG. 10, the added program control unit 170 may be configured to register its own ID information in the SCS 169 as a destination of a job status change notice, upon starting up of the added program control unit 170 as a process (which is normally upon starting up of the device 20). Thus, the SCS 169 may send the notices in steps S221 and S222 based on the registered ID information. In this way, the behavior of the SCS 169 can be dynamically controlled.

As described above, in accordance with Embodiment 1, the application (validation) of an added program during the execution of a job can be properly controlled based on the job-executing application determination table 181. Thus, application of an added program to a target program that is not suitable for such application during the execution of a job can be prevented.

### Embodiment 2

### Handling of Added Program Depending on Offline Status

In accordance with Embodiment 2, the added program is handled depending on an offline status that indicates the status of the device 20 from a different viewpoint from the job status.

Generally, the term “offline” refers to a status where a device and the like is not connected to a network and the like. In accordance with the present embodiment, however, “offline” refers to a status where the execution of a program or a function is limited by the circumstance of another program or function within the device 20. Such limiting circumstance of a program and the like may be present when the program sets a parameter in accordance with a user instruction that affects the operation of plural programs; or when the device 20 as a whole or a group of its processes is rebooted so as to validate such a parameter setting. Thus, “offline” in the context of the present embodiment means that the function of a program and the like is not valid. A normal status as opposed to the offline status may be referred to as “the online status”.

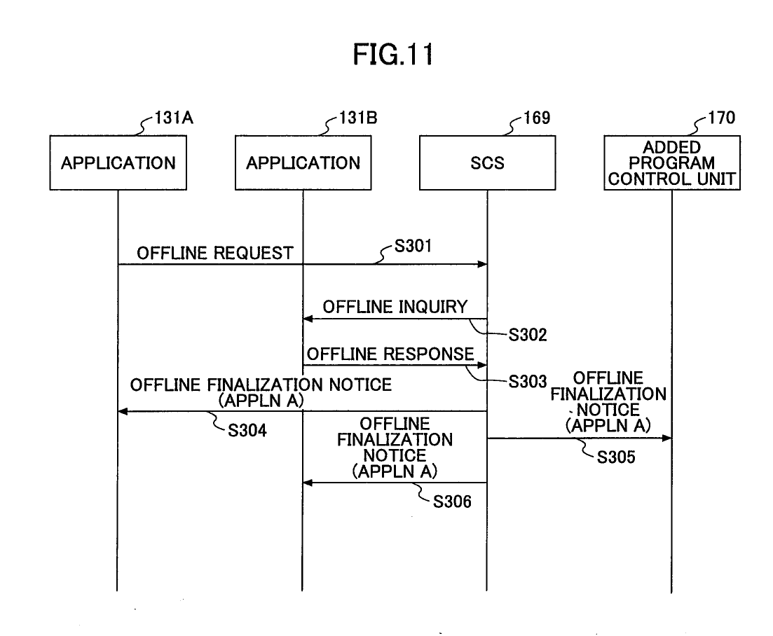

First, as a prerequisite of the second embodiment, a process sequence of transition of the device 20 to the offline status is described with reference to a sequence diagram of FIG. 11. An application 131A is a program that causes the transition to the offline status. An application 131B may include a program or a group of programs that are affected by the transition to the offline status.

First, the application 131A receives an instruction for execution of a process that requires transition to the offline status via the operating panel 602 or a network and the like. The instruction may include an instruction for setting a parameter. In response to such an instruction, the application 131A sends an offline request (requesting transition to the offline status) to the SCS 169 (S301). In response to the offline request, the SCS 169 queries the application 131B as to whether transition to the offline status can be made (S302). The application 131B that receives the query may be an application whose ID information has been registered in the SCS 169 in advance (such as upon starting up of the application 131B) as a program that is affected by the offline status. Then, the application 131B sends a reply to the SCS 169 depending on its own status (S303). For example, when the application 131B is executing a process that should not be interrupted, the application 131B replies that the transition to the offline status cannot be made. On the other hand, when the process being executed by the application 131B may be interrupted, or when the application 131B is not executing any process, the application 131B replies that the transition to the offline status can be made.

When the reply from the application 131B indicates that transition to the offline status is allowed, the SCS 169 sends an offline finalization notice to the application 131A that made the offline request and to the added program control unit 170 and the application 131B that are registered in advance as destinations for the offline status transition notice (S304 through S306). The offline finalization notice may include the program ID of the program (application 131A) that caused the transition to the offline status.

Thus, the device 20 transitions to the offline status. The behavior of the programs upon reception of the offline finalization notice (i.e., their behavior in the offline status) may depend on the implementation of the programs.

The lifting of the offline status (i.e., return to the online status) may be realized when a process sequence similar to FIG. 11 is performed in response to an online request from the application A 131 that caused the offline status. Namely, the application A 131 may send an online request to the SCS 169 after parameter setting or rebooting.

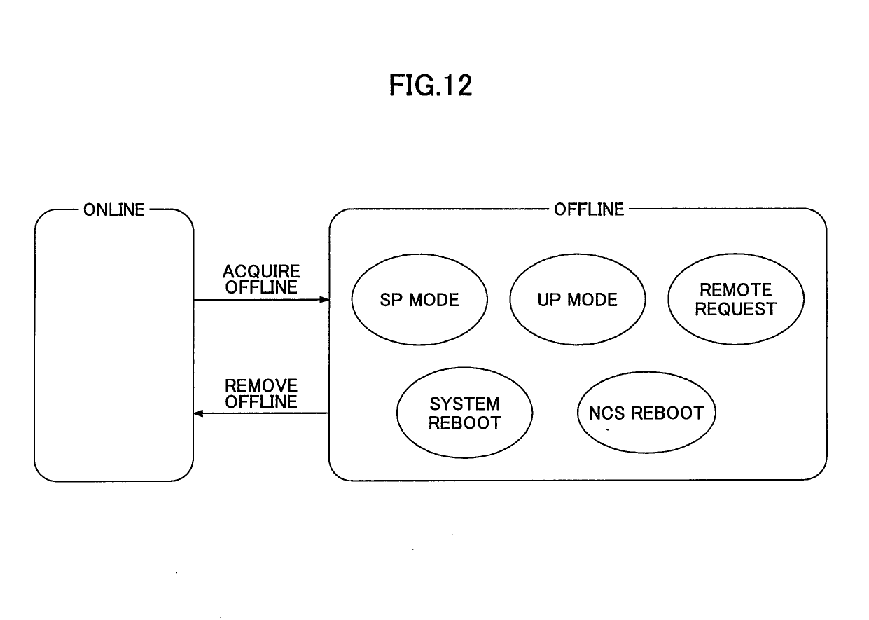

The offline status may include plural offline modes. These offline modes are described with reference to FIG. 12. FIG. 12 describes a transition between the online status and the offline status. In the online status, the device 20 transitions to the offline status upon “offline acquisition”. The agent of offline acquisition is the program that makes an offline request. In other words, in accordance with the present embodiment, the application 131A causing the device 20 to transition to the offline status, as described in FIG. 11, is expressed as “the application 131A acquiring offline status”.

In the example of FIG. 12, the offline status includes various modes including an “SP mode”, an “UP mode”, a “remote request mode”, a “system reboot mode”, and an “NCS reboot mode”.

The SP mode refers to a status in which a setting screen used by service personnel (such as a maintenance worker from the manufacturer of the device 20) is being displayed. The UP mode refers to a status in which an initial setting screen used by an end-user is being displayed. The remote request mode refers to a status in which setting information (such as a parameter) is being updated via a network. The system reboot mode refers to a status in which the device 20 is rebooted. The NCS reboot refers to a status in which a process of the NCS 161 is rebooted.

Thus, in FIG. 11, the application 131A may send an offline request to the SCS 169 with a designation of an offline status mode. In response to the query as to whether transition to the offline status is possible, the application 131B may determine whether transition to the designated mode of offline status is possible, and then send a determination result to the SCS 169. Further, in response to an offline finalization notice, each program may behave in accordance with the designated mode.

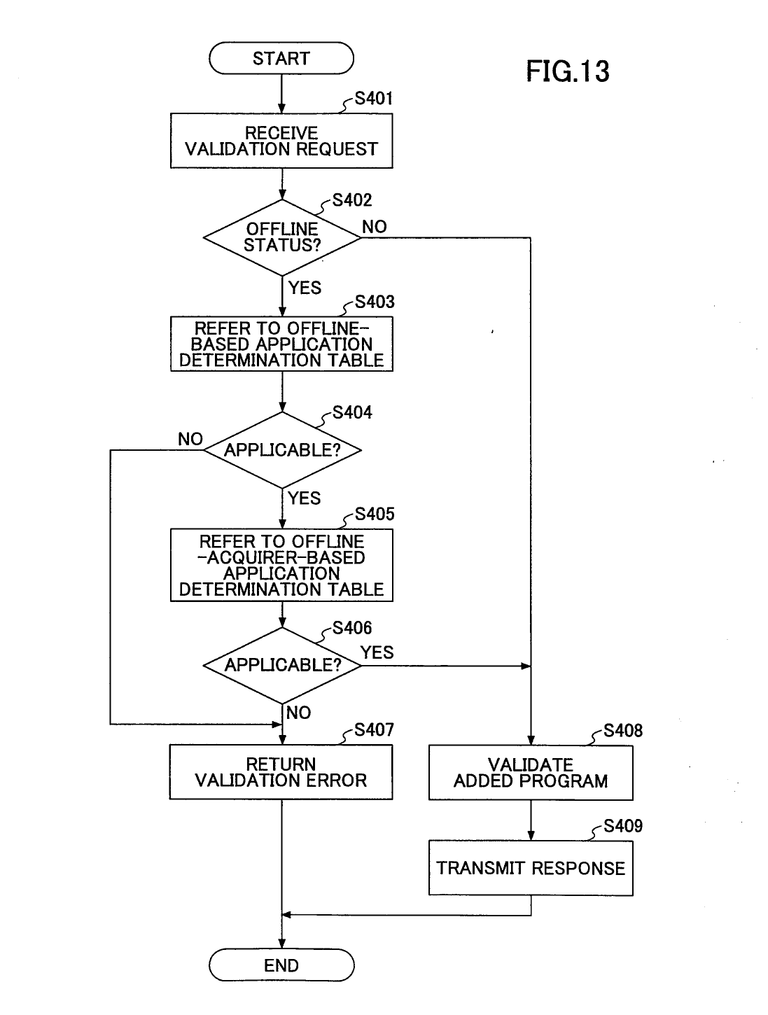

Next, the handling of an added program by the added program control unit 170 in accordance with the offline status is described. FIG. 13 is a flowchart of a process sequence of the added program control unit 170 according to Embodiment 2. In step S401, the added program control unit 170 receives a validation request from the management server 10, the request designating an added program ID of an added program as a validation target. When not in the offline status (NO in S402), the added program control unit 170 validates the added program corresponding to the added program ID (S408). Thereafter, the added program control unit 170 transmits a reply to the management server 10 indicating that the added program has been correctly validated (S409). Whether the device 20 is in the offline status can be determined depending on whether an offline finalization notice has been received from the SCS 169.

When in the offline status (YES in S402), the added program control unit 170 refers to an offline-mode-based application determination table and determines whether the added program can be applied (S403).

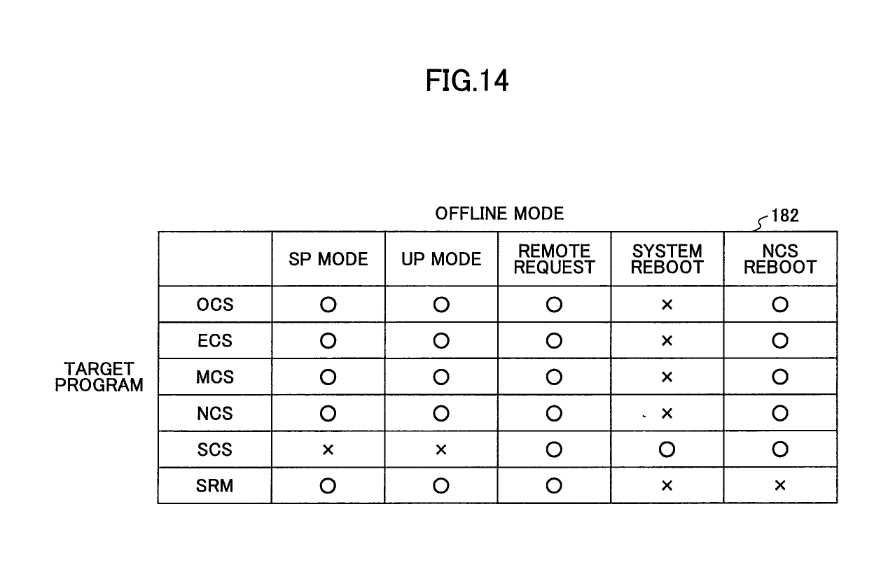

FIG. 14 is an example of the offline-mode-based application determination table according to the second embodiment. As illustrated in FIG. 14, the offline-mode-based application determination table 182 records (registers) information indicating whether an added program can be applied with respect to each program ID of possible target programs in the device 20 and with respect to each offline mode. Specifically, “Yes” indicates that the added program can be applied, while “No” indicates that the added program cannot be applied. The offline-mode-based application determination table 182 may be recorded in a non-volatile recording medium, such as the HDD 633, in advance.

Thus, the added program control unit 170 determines whether the added program can be applied by referring to the offline-mode-based application determination table 182 and comparing the target program ID attached to the added program with the current offline mode. If the determination provides a positive result (YES in S404), the added program control unit 170 refers to an offline-acquirer-based application determination table in order to determine whether the added program can be applied (S405).

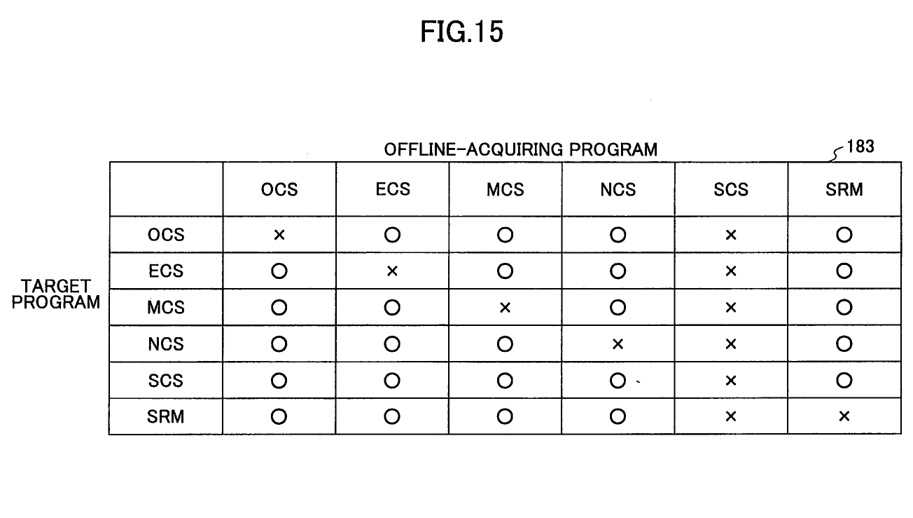

FIG. 15 is an example of the offline-acquirer-based application determination table 183 according to the second embodiment. As illustrated in FIG. 15, the offline-acquirer-based application determination table 183 records (registers) information indicating whether the added program can be applied, with respect to each program ID of possible target programs in the device 20 and with respect to the program ID of the offline acquirer (i.e., the program that acquires offline). In the illustrated table, “Yes” indicates that application is possible, while “No” indicates that application is not possible. The offline-acquirer-based application determination table 183 may be recorded in a non-volatile recording medium, such as the HDD 633, in advance.

Thus, the added program control unit 170 determines whether the added program can be applied by referring to the offline-acquirer-based application determination table 183 and comparing the target program ID attached to the added program and the program ID of the offline mode acquirer with the offline-acquirer-based application determination table 183. If the determinations provides a positive result (YES in S406), steps S408 and S409 are carried out as described above. If the determination in step S403 or S405 provides a negative result (NO in S404 or S406), the added program control unit 170 sends a reply to the management server 10 indicating that validation of the added program has not been successful (S407). Whereas in accordance with Embodiment 1, there is the standby period for transition from the job executing status to the idle status, there is no such standby period in accordance with Embodiment 2. This is due to the characteristics of the offline status, as described below.

The offline status is a status in which a user may make various parameter settings or reboot the device. Such setting operation by the user may take a very long time and it cannot be predicted when it will end. Thus, it is not appropriate to delay the validation of the added program until the offline status is lifted. Further, rebooting involves the severing of a session with the management server 10, which makes it difficult to continue communications with the management server 10.

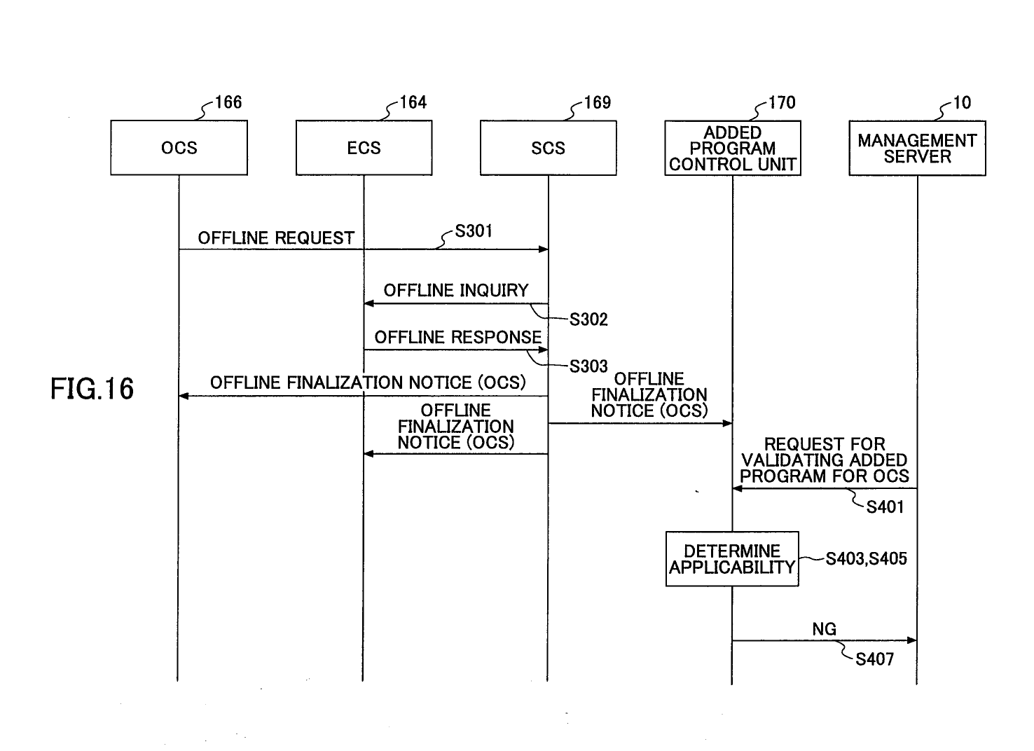

Next, the process sequence of FIG. 13 is described with reference to a more specific example. FIG. 16 is a first sequence diagram of the process in which validation of an added program is requested in the offline status. In FIG. 16, steps similar to the steps of FIG. 11 or 13 are designated with similar step numbers. In the example of FIG. 16, the OCS 166 corresponds to the application 131A, and the ECS 164 corresponds to the application 131B. Thus, in the example of FIG. 16, the OCS 166 acquires offline, transitioning the device 20 to the offline status.

In the offline status, the added program control unit 170 receives, from the management server 10, an validation request, designating the program ID of the OCS 166 as a target program (S401). In response to the validation request, the added program control unit 170 determines whether the added program can be applied (S403, S405). In the illustrated example, it is determined that the application is not allowed, based at least on the offline-acquirer-based application determination table 183. Namely, the offline-acquirer-based application determination table 183 of FIG. 15 indicates “No” for the application of an added program for the OCS 166 as a target program when the offline acquirer is the OCS 166. Thus, the added program control unit 170 sends a reply to the management server 10 indicating that validation of the added program has been unsuccessful (S407).

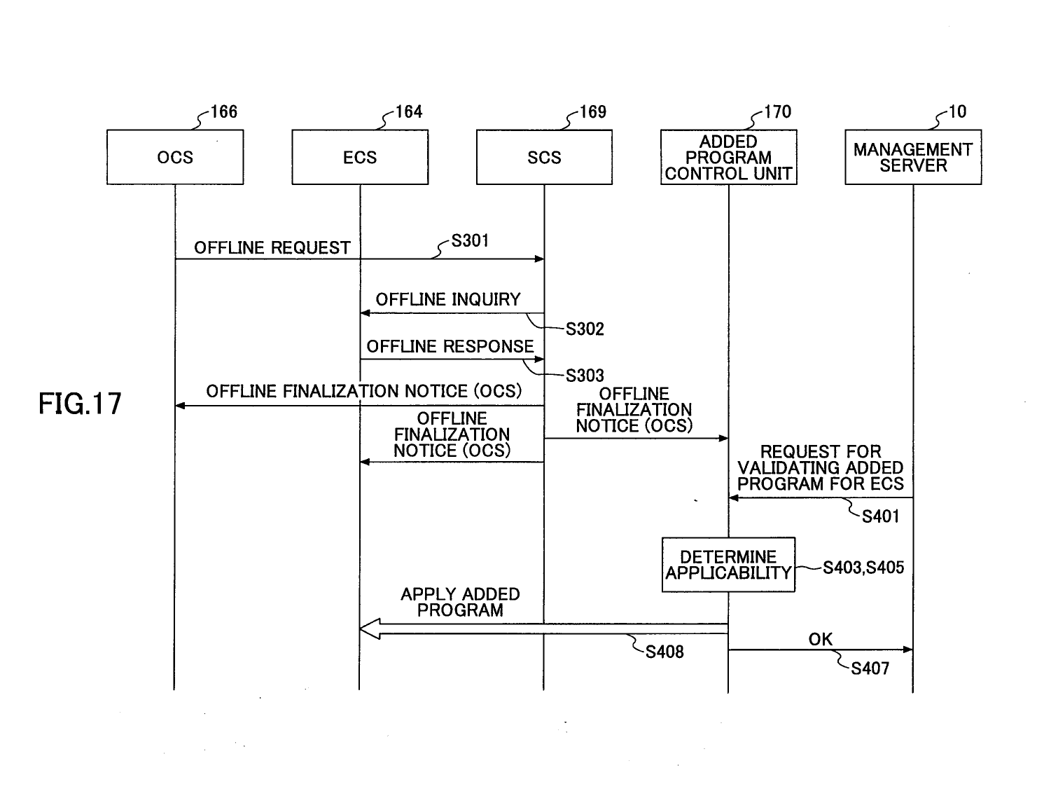

FIG. 17 is a sequence diagram of a second process sequence of the process in which validation of an added program is requested in the offline status. In FIG. 17, steps similar to the steps of FIG. 16 are designated with similar step numbers. The example of FIG. 17 differs from FIG. 16 in that the validation request in step S401 contains the program ID of the ECS 164 as a target program ID. Thus, it is determined that the application of the added program is allowed unless the offline mode is the system reboot mode (see FIG. 14). Namely, the offline-acquirer-based application determination table 183 of FIG. 15 indicates “Yes” for the application of the added program for the ECS 164 as a target program when the offline acquirer is the OCS 166. Therefore, in this case, the added program control unit 170 validates the added program (S408), so that the added program is applied to the ECS 164. Thereafter, the added program control unit 170 transmits a reply to the management server 10 indicating the successful validation of the added program (S409).

As described above, in accordance with Embodiment 2, application (validation) of an added program in the offline status can be appropriately controlled based on the offline application determination table 182 and the offline-acquirer-based application determination table 183. Thus, the application of an added program to a target program that is not suitable for such application in the offline status can be prevented.

### Embodiment 3

### Handling of Added Program Depending on Power Status

In accordance with Embodiment 3, the added program is handled in accordance with a power status (power supply status), which is a different category of status of the device 20 from the first embodiment or the second embodiment.

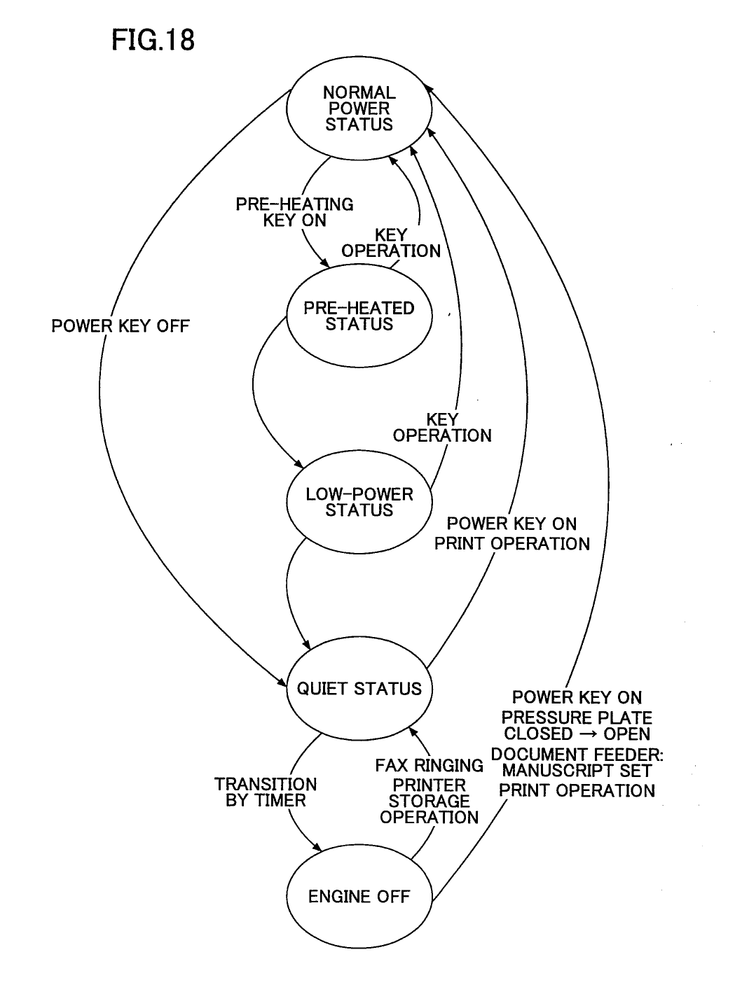

FIG. 18 illustrates the transition of power status of the device 20 in accordance with Embodiment 3. In the illustrated example, the power status of the device 20 includes a normal power status, a pre-heating status, a low-power status, a quiet status, and an engine OFF status. The normal power status refers to a status in which a variety of jobs can be performed immediately. The normal power status of the device 20 may transition to the pre-heating status upon pressing of a pre-heating key on the operating panel 602, or when a no-operation status has continued for a predetermined time. The pre-heating status refers to a status in which power consumption is reduced from the normal power status. In the pre-heating status, the temperature of the fusing unit of the printer 605 may be lowered.

When the pre-heating status continues without any operation for a predetermined time, the power status of the device 20 may transition to a lower power consumption status, such as from the low-power status to the quiet status. In the quiet status, supply of power to the fusing unit may be terminated while access to the HDD 633 may be allowed. The normal power status may also transition to the quiet status upon pressing of a power supply key. The power supply key is different from a power supply switch in that the power supply switch is a switch for turning on or off the power to the device 20. On the other hand, the power supply key is a key (or a button) for switching the power status of the device 20 between the normal power status and the quiet status, for example. When the quiet status continues without any operation for a predetermined time, the power status of the device 20 may transition to the engine OFF status. In the engine OFF status, power consumption is minimum. Notices of such transitions of power status are also sent to the SCS 169. Thus, the SCS 169 can recognize what power status the device 20 is currently in.

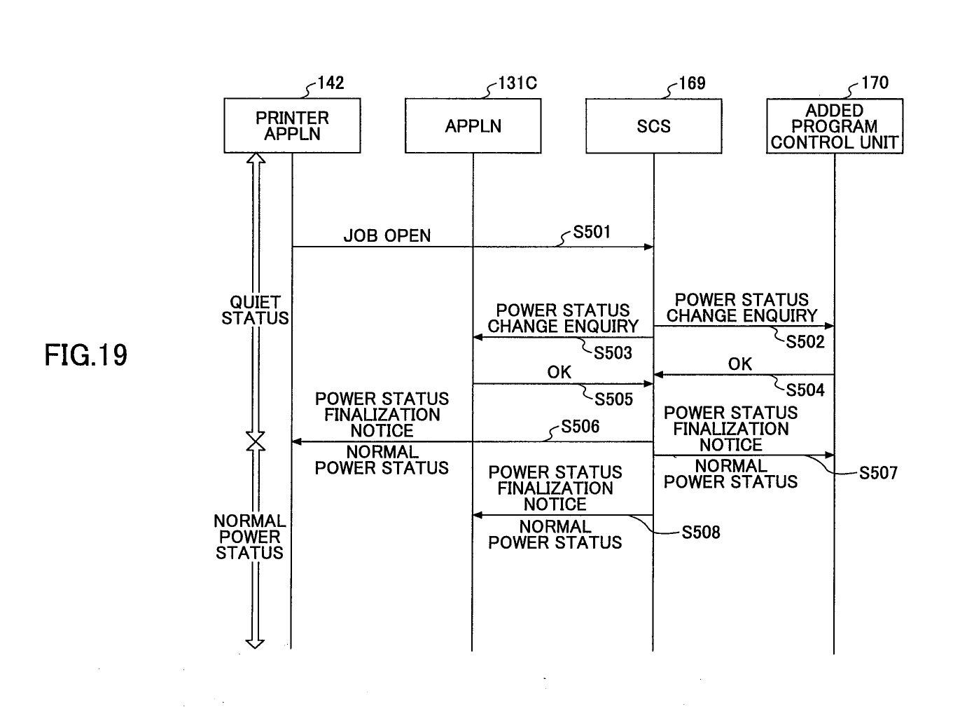

In statuses other than the normal power status, the power status of the device 20 may transition to the normal power status upon a user making a key operation. For example, FIG. 19 is a sequence diagram of a process sequence in which the device 20 transitions from the quiet status to the normal power status. In the illustrated example, an application 131C may include a program or group of programs that are registered in the SCS 169 in advance as destinations of a power status transition notice.

For example, in the quiet status, upon reception of a print request from a PC (personal computer) connected via a network, the printer application 142 sends “job open” to the SCS 169 (S501). As described with reference to FIG. 5, the SCS 169 is notified of “job open” via the ECS 164; in FIG. 19, however, the presence of the ECS 164 is omitted.

In response to the job open notice, the SCS 169 determines that the power status of the device 20 needs to be transitioned from the quiet status to the normal status. Thus, the SCS 169 queries the added program control unit 170 and the application 131C, which are registered in the SCS 169 in advance as the destinations of a power status transition notice, as to whether the transition from the quiet status to the normal power status is allowed (S502, S503). In response, the added program control unit 170 and the application 131C reply to the SCS 169 depending on their individual statuses (S504, S505).

When all of the responses from the destinations to the query indicate that the transition to the normal power status is allowed, the power status of the device 20 physically transitions to the normal power status under the control of the SCS 169.

Thereafter, the SCS 169 sends a power status finalization notice to the printer application 142, added program control unit 170, and the application C 131C, which are registered in the SCS 169 as the destinations of a power status transition notice, indicating the transition of the power status to the normal power status (S506 through S508).

While the example of FIG. 19 involves the transition from the quiet status to the normal power status, other transitions of power status may be realized with similar process sequences. Thus, the added program control unit 170 can be informed about the current power status at all times by the notices sent in step S507.

The above-described handling of the added program depending on the transition of power status may be realized in the same way as in Embodiment 2. Namely, the added program control unit 170 according to Embodiment 3 may be configured to perform a process sequence similar to the process sequence of FIG. 13. In this case, instead of the offline-mode-based application determination table 182, a power-status-based application determination table may be used in which the respective columns are headed by the various power statuses instead of the offline modes. Such a power-status-based application determination table allows the determination of whether an added program can be applied to each target program with respect to each power status. On the other hand, no table corresponding to the offline-acquirer-based application determination table 183 may be required. Thus, in accordance with Embodiment 3, steps corresponding to steps S405 and S406 in FIG. 13 may be omitted.

As described above, in accordance with Embodiment 3, the application (validation) of the added program in each power status can be properly controlled based on the power-status-based application determination table. Thus, the application of an added program to a target program to which such application is meaningless in the quiet status, for example, can be prevented.

### Embodiment 4

### Automatic Validation of Added Program

In Embodiments 1 through 3, the added program control unit 170 determines the possibility of validation (application) of an added program in response to the reception of an added program validation request from the management server 10. On the other hand, in accordance with Embodiment 4, the added program control unit 170 is configured to automatically or actively validate an added program suitable for a detected status of the device 20. The status of the device 20 in accordance with Embodiment 4 may refer to the job status, the offline status, or the power status.

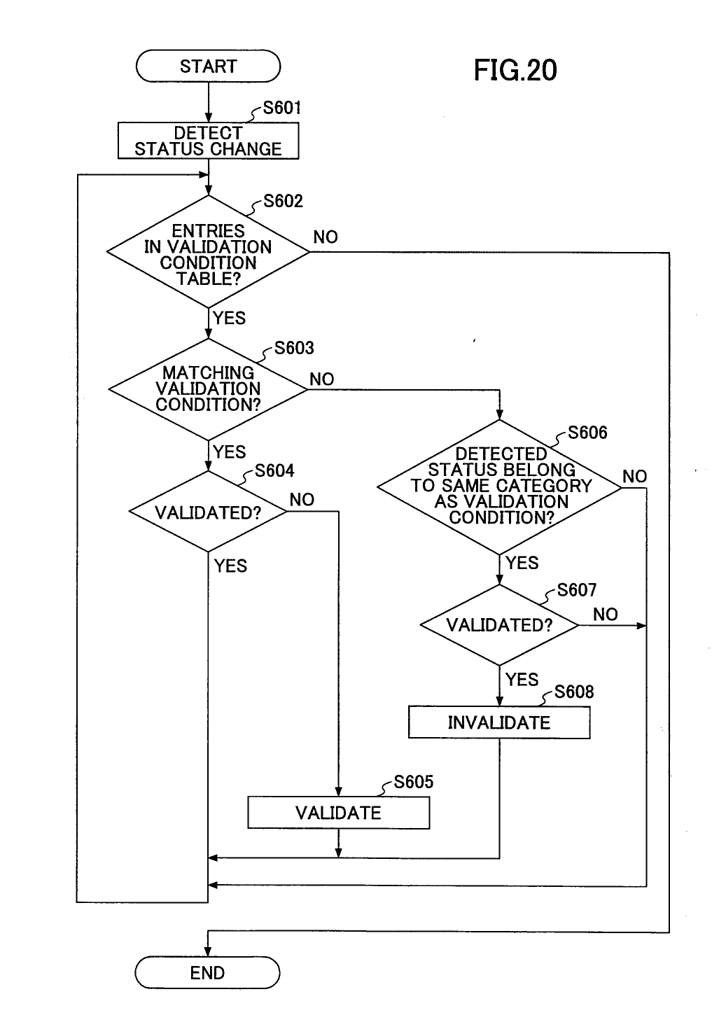

FIG. 20 is a flowchart of a process sequence of the added program control unit 170 according to Embodiment 4. Upon detection of a change in the status of the device 20, the added program control unit 170 determines whether there is one or more unprocessed added programs in a validation condition table 190. If there are, one of such unprocessed added programs is selected as a process target (S601). The change in status may be detected in response to the offline finalization notice from the SCS 169 in step S305 of FIG. 11 when the status of the device 20 is indicated by the offline status. When the status of the device 20 is indicated by the power status, the detection of the status change may be based on the power status finalization notice from the SCS 169 in step S507 of FIG. 19. In the case of the job status, the status change may be detected by the added program control unit 170 polling the SCS 169 concerning the job status. Alternatively, in the example of FIG. 10, the status change may be detected upon reception of the notice from the SCS 169 in step S221.

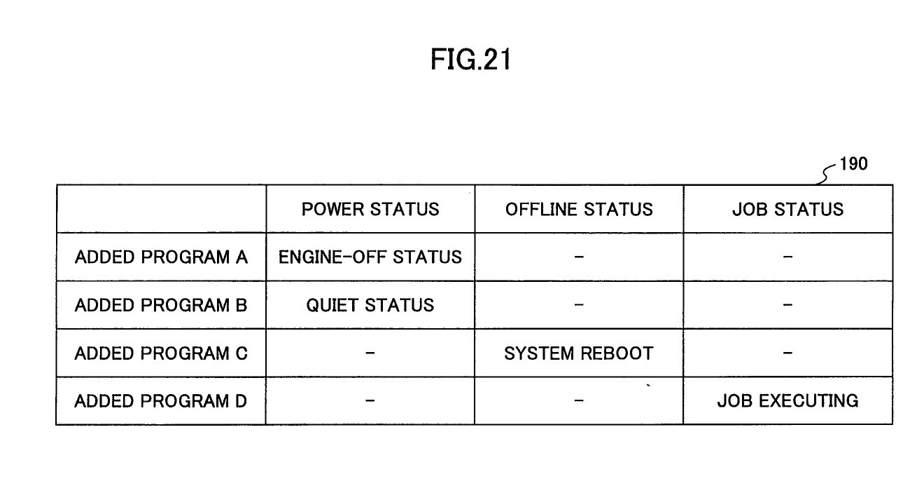

FIG. 21 illustrates an example of a validation condition table 190, which records (registers) information indicating validation conditions for each added program. The conditions are designated by the power status, the offline status, or the job status. In the illustrated example, four added programs A through D are registered. The validation condition for the added program A is that the power status indicates the engine OFF status. The validation condition for the added program B is that the power status indicates that the quiet status. The validation condition for the added program C is that the offline status indicates a system-rebooting status. The validation condition for the added program D is that the job status indicates that a job is being executed. Two or more such conditions may be combined. The validation condition table 190 may be recorded in a non-volatile recording medium, such as the HDD 633, in advance.

When step S602 is initially performed, the added program A is selected as a process target. In the following, the added program that is selected as a process target may be referred to as “a current added program”. Thereafter, the added program control unit 170 determines whether the status detected in step S601 matches the validation condition for the current added program (S603). If the detected status matches the validation condition, the added program control unit 170 then determines whether the current added program is already validated (S604). Because the added program control unit 170 is responsible for validating the added program, the added program control unit 170 has information of a list of the currently validated added programs. For example, a list of the added program IDs of the currently validated added programs is recorded in memory. Thus, the added program control unit 170 can determine which added program is validated.

When the current added program is not validated (NO in S604), the added program control unit 170 validates the current added program (S605). When the current added program is already validated (YES in S604), the added program control unit 170 does nothing with respect to the current added program, and selects the next added program registered in the validation condition table 190 as the current added program.

On the other hand, when the detected status does not match the validation condition of the current added program (NO in S603), the added program control unit 170 determines whether the detected status belongs to the same category of status as the validation condition of the current added program (S606). For example, in the case of the added program A, the determination provides a positive result when the detected status indicates a power status other than the engine OFF status. On the other hand, when the detected status belongs to the same category as the offline status or the job status, the determination provides a negative result.

When the detected status belongs to the same category of status as the validation condition of the current added program (YES in S606), the added program control unit 170 determines whether the current added program is already validated (S607). If validated (YES in S607), the added program control unit 170 invalidates the current added program (S608). To “invalidate” means that the application of the added program to the target program (i.e., insertion of an interrupt instruction) is removed. By such invalidation, the process sequence of the target program returns to normal.

When the detected status does not belong to the same category of status as the validation condition of the current added program (NO in S606), or when the current added program is not validated (NO in S607), the added program control unit 170 does nothing with respect to the current added program, and instead selects the next added program registered in the validation condition table 190 as the current added program.

When the steps following step S602 are completed for all of the added programs registered in the validation condition table 170, the process of FIG. 20 ends.

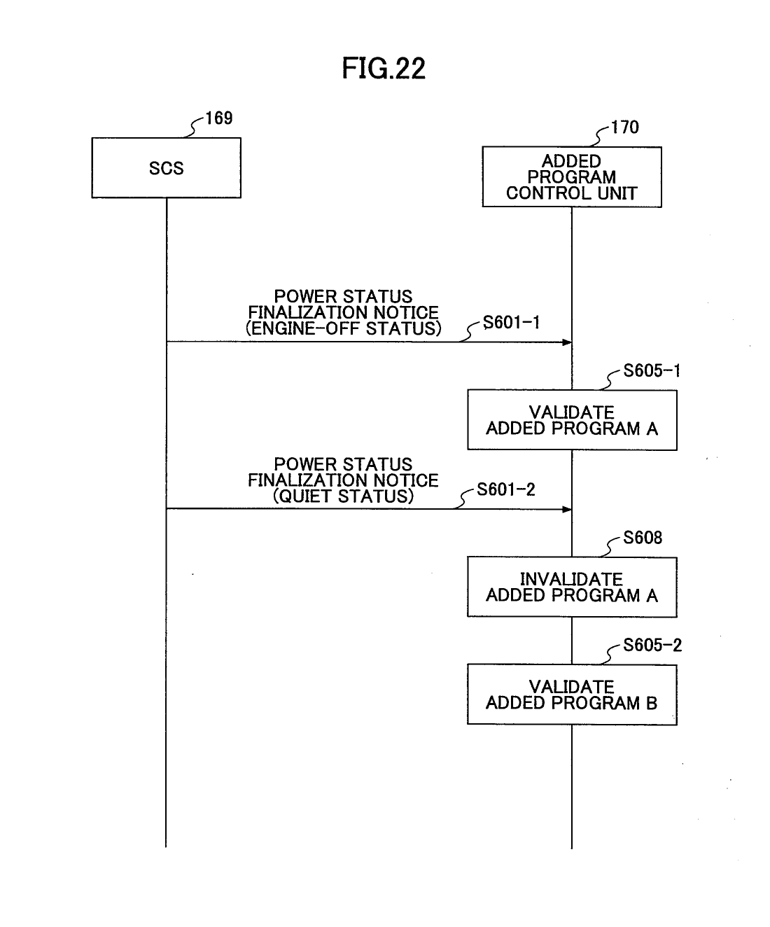

Next, the process sequence of FIG. 20 is described with reference to a more specific example. FIG. 22 is a sequence diagram of a first process sequence of the added program validation process depending on the device status change. In FIG. 22, steps similar to the steps of FIG. 20 are designated with similar step numbers.

For example, upon reception of a power status finalization notice from the SCS 169 indicating the transition to the engine OFF status (S601-1), the added program control unit 170 validates the added program A based on the validation condition table 190 of FIG. 21 (S605-1).

Thereafter, upon reception of a power status finalization notice from the SCS 169 indicating the transition to the quiet status when the added program A is validated (S601-2), the added program control unit 170 invalidates the added program A based on the validation condition table 190 (S608), and further validates the added program B (S605-2).

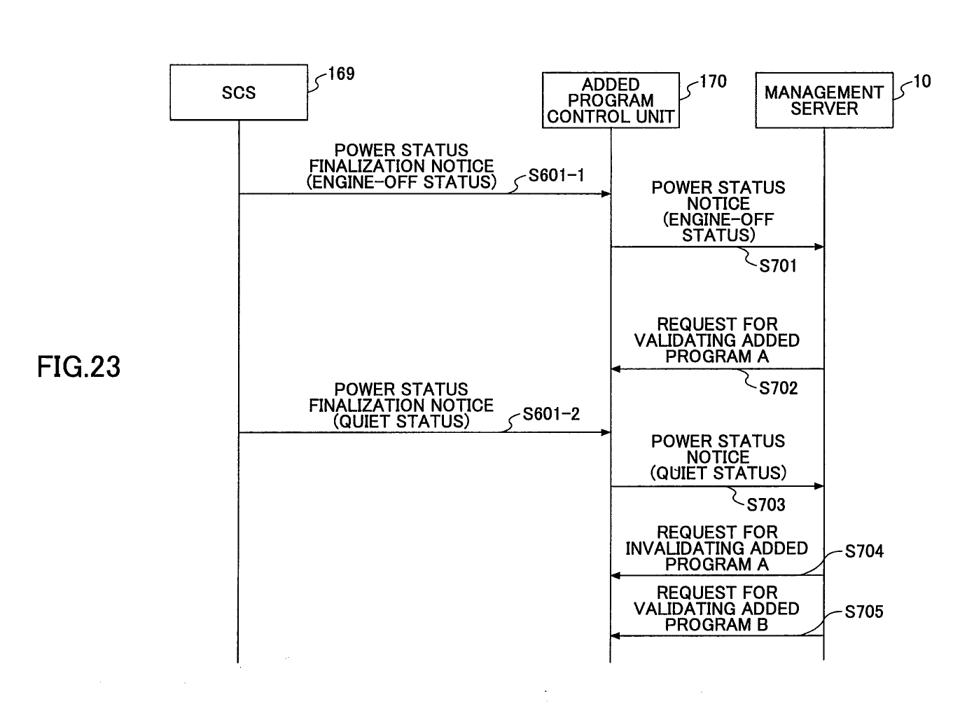

Next, a variation of the process sequence of FIG. 22 is described with reference to FIG. 23, which is a sequence diagram of a second process sequence of the added program validation process depending on the device status change. In FIG. 23, steps similar to the steps of FIG. 22 are designated with similar step numbers. Further, in the example of FIG. 23, the validation condition table 190 is provided in the management server 10.

For example, following the reception of a power status finalization notice from the SCS 169 indicating the transition to the engine OFF status (S601-1), the added program control unit 170 notifies the management server 10 (S701). In response, the management server 10 performs the process illustrated in FIG. 20, involving the transmission of an validation request for the added program A to the added program control unit 170 (S702). In response to the validation request, the added program control unit 170 validates the added program A. While omitted in FIG. 23, when the validation is successful, the added program control unit 170 notifies the management server 10 of a successful validation of the added program A. Thus, the management server 10 can recognize that the added program A is validated.

Thereafter, when the added program A is validated, upon reception of a power status finalization notice from the SCS 169 indicating the transition to the quiet status (S601-2), the added program control unit 170 notifies the management server 10 (S703). In response, the management server 10 performs the process of FIG. 20, involving the transmission of an invalidation request for the added program A and an validation request for the added program B to the added program control unit 170 (S704, S705). In response, the added program control unit 170 invalidates the added program A and validates the added program B.

Thus, the validation condition table 190 may be provided in the management server 10. In this case, the process of FIG. 20 may be performed by the management server 10.

As described above, in accordance with the fourth embodiment, the added program can be validated or invalidated automatically depending on the status of the device 20 based on the validation condition table 190. Thus, the timing of application of the added program can be controlled.

Embodiment 4 may be combined with any one of Embodiments 1 through 3. In this case, whether an added program should be validated may be determined by the process of any one of Embodiments 1 through 3. Alternatively, the processes of Embodiments 1 through 4 may be combined in a desired way.

While in the foregoing description of the embodiments an image forming apparatus has been described as an electronic device, the present invention may be applied to various other electronic devices, such as various digital household appliances, portable devices, and general-purpose computers.

A computer-readable program having a program code for performing an information processing method according to an embodiment of the present invention may be embodied in a non-transitory computer-readable medium, such as the memory card 635 or a computer-readable information recording disc (not shown). Such a computer-readable program may also be downloaded into the electronic device 20 from the outside via the NIC 641 through a network, such as the Internet.

Although this invention has been described in detail with reference to certain embodiments, variations and modifications exist within the scope and spirit of the invention as described and defined in the following claims.

The present application is based on Japanese Priority Application No. 2009-161105 filed Jul. 7, 2009, the entire contents of which are hereby incorporated by reference.

What is claimed is:

1. An electronic device comprising:
a status management unit configured to detect a change in a status of the electronic device and recognize the status;
an added program control unit configured to apply an added program to a program of the electronic device in response to a validation request for the added program, the added program being capable of dynamically interrupting the program of the electronic device with a process; and
an application determination information storage unit configured to store application determination information indicating whether the added program can be applied to the program of the electronic device depending on the status of the electronic device recognized by the status management unit,
wherein the added program control unit determines whether the added program can be applied in accordance with the validation request based on
the status of the electronic device recognized by the status management unit upon reception of the validation request; and
the application determination information stored in the application determination information storage.

2. The electronic device according to claim 1, wherein the added program control unit is configured to apply the added program to the program of the electronic device after waiting until the status of the electronic device transitions to a status allowing the application of the added program, when the added program control unit determines that the added program cannot be applied.

3. The electronic device according to claim 1, wherein the status of the electronic device includes
a job status;
a status in which the execution of a process of the program in the electronic device is limited; and
a power status.

4. The electronic device according to claim 1, further comprising a validation condition storage unit configured to store validation condition information specifying a condition for validating the added program depending on the status of the electronic device,
wherein the added program control unit is configured to
determine whether the added program should be validated based on the validation condition information stored in the validation condition storage unit upon detection of the change in the status of the electronic device by the status management unit; and
apply the added program to the program of the electronic device upon determination by the added program control unit that the added program should be validated.

5. The electronic device according to claim 1, wherein the electronic device is connected to a computer via a network, the computer having a validation condition storage unit configured to store validation condition information specifying a condition for validating the added program depending on the status of the electronic device detected by the status management unit,
wherein the added program control unit is configured to
notify the computer upon detection of the change in the status of the electronic device by the status management unit;
receive a determination result from the computer which is based on the detected status of the electronic device and the validation condition information stored in the validation condition storage unit; and
apply the added program to the program of the electronic device when the determination result from the computer indicates that the added program should be validated.

6. An information processing method performed by an electronic device, the method comprising:
a status managing step of detecting a change in a status of the electronic device and recognizing the status of the electronic device; and
an added program control step of applying an added program to a program of the electronic device in response to a validation request for the added program, the added program being capable of dynamically interrupting the program of the electronic device with a process,
wherein the added program control step includes determining whether the added program can be applied in accordance with the validation request based on
the status of the electronic device recognized by the status managing step in response to the validation request, and
application determination information stored in an application determination information storage unit of the electronic device,
the application determination information indicating whether the added program can be applied depending on the status of the electronic device.

7. The information processing method according to claim 6, wherein the added program control step includes applying the added program to the program of the electronic device after waiting until the status of the electronic device transitions to a status allowing the application of the added program, when the added program control step determines that the added program cannot be applied.

8. The information processing method according to claim 6, wherein the status of the electronic device includes
a job status;
a status in which the execution of a process of the program of the electronic device is limited; and
a power status.

9. The information processing method according to claim 6, wherein the added program control step includes
determining whether the added program should be validated in response to the detection of the change in the status of the electronic device by the status managing step, based on validation condition information stored in a validation condition storage unit of the electronic device,
the validation condition information specifying a condition for validating the added program depending on the status of the electronic device; and
applying the added program to the program of the electronic device upon determination by the added program control step that the added program should be validated.

10. The information processing method according to claim 6, wherein the electronic device is connected to a computer via a network,
the computer having a validation condition storage unit configured to store validation condition information specifying a condition for validating the added program depending on the status of the electronic device,
wherein the added program control step includes
notifying the computer of the change in the status of the electronic device detected by the status managing step;
receiving a determination result from the computer which is based on the notified change in the status of the electronic device, and the validation condition information stored in the validation storage unit; and
applying the added program to the program of the electronic device when the determination result indicates that the added program should be validated.

11. A computer program product comprising a computer-readable information processing program embodied in a non-transitory computer-readable medium and including a program code to be executed by a computer to perform
a status managing step of detecting a change in a status of an electronic device and recognizing the status of the electronic device; and
an added program control step of applying an added program to a program of the electronic device in response to a validation request for the added program, the added program being capable of dynamically interrupting the program with a process,
wherein the added program control step includes determining whether the added program can be applied to the program of the electronic device in accordance with the validation request based on
the status of the electronic device recognized by the status managing step in response to the validation request; and
application determination information stored in an application determination information storage unit of the electronic device,
the application determination information indicating whether the added program can be applied depending on the status of the electronic device.

12. The computer program product according to claim 11, wherein the added program control step includes applying the added program to the program of the electronic device after waiting until the status of the electronic device transitions to a status allowing the application of the added program, when the added program control step determines that the added program cannot be applied.

13. The computer program product according to claim 11, wherein the status of the electronic device includes
a job status;
a status in which the execution of a process of the program of the electronic device is limited; and
a power status.

14. The computer program product according to claim 11, wherein the added program control step includes
determining whether the added program should be validated in response to the detection of the change in the status of the electronic device by the status managing step, based on validation condition information stored in a validation condition storage unit of the electronic device,
the validation condition information specifying a condition for validating the added program depending on the status of the electronic device; and
applying the added program to the program of the electronic device upon determination in the added program control step that the added program should be validated.

15. The computer program product according to claim 11, wherein the electronic device is connected to a computer via a network,
the computer having a validation condition storage unit configured to store validation condition information specifying a condition for validating the added program depending on the status of the electronic device,
wherein the added program control step includes
notifying the computer upon detection of the change in the status of the electronic device by the status managing step;
receiving a determination result from the computer which is based on the notified change in status and the validation condition information stored in the validation storage unit; and
applying the added program to the program of the electronic device when the determination result indicates that the added program should be validated.
